(19) United States
(12) Patent Application Publication
(10) Pub. No.: US 2024/0101806 A1
(43) Pub. Date: Mar. 28, 2024

(54) STYRENE-BASED RESIN COMPOSITION

(71) Applicant: IDEMITSU KOSAN CO., LTD., Chiyoda-ku, Tokyo (JP)

(72) Inventors: Shota TAKIGUCHI, Chiba-shi, Chiba (JP); Naoto OKUBO, Chiba-shi, Chiba (JP); Seita KIMURA, Sodegaura-shi, Chiba (JP); Yukio ANZAWA, Chiba-shi, Chiba (JP)

(21) Appl. No.: 18/262,289

(22) PCT Filed: Jan. 13, 2022
(86) PCT No.: PCT/JP22/00990

§ 371 Date: Jul. 20, 2023

(30) Foreign Application Priority Data
Jan. 22, 2021 (JP) 2021-008795

(51) Int. Cl. C08L 25/06; C08K 3/013; C08K 3/40; C08K 5/00; C08K 9/02; C08K 9/06

(52) U.S. Cl. CPC C08L 25/06; C08K 3/013; C08K 3/40; C08K 5/0041; C08K 9/02; C08K 9/06; C08K 2201/019; C08L 2205/08; C08L 2207/10

(57) ABSTRACT

A styrene-based resin composition containing a styrene-based resin (A) having a syndiotactic structure, a styrene-based elastomer (B), a compatibilizer (C), an inorganic filler (D), and a colorant (E), having a content of the styrene-based elastomer (B) of 2.0 to 30.0% by mass based on the total amount of the styrene-based resin (A) having a syndiotactic structure, the styrene-based elastomer (B) and the compatibilizer (C) as 100% by mass, and a content of the colorant (E) of 0.0001 to 6.5% by mass based on the entire amount of the styrene-based resin composition as 100% by mass.

### TECHNICAL FIELD

The present invention relates to a styrene-based resin composition.

### BACKGROUND ART

A styrene-based resin having a syndiotactic structure (i.e., syndiotactic polystyrene, which may be hereinafter referred to as SPS) has excellent capabilities in mechanical strength, heat resistance, electric characteristics, dimensional stability in absorbing water, chemical resistance, and the like. SPS is therefore significantly useful as a resin used in various applications, such as an electric or electronic device material, an automobile electric component, a domestic electric appliance, various machine components, and industrial materials.

SPS has been considered to blend with another resin for controlling the balance among the multiple capabilities in the characteristics of the SPS, such as the strength, the toughness, the heat resistance, the chemical resistance, and the moldability.

For example, PTL 1 describes a styrene-based resin composition and the like for the simultaneous achievement of the hot water resistance, the releasability, and the low gas emission, containing a particular amount of a glass filler, a styrene-based resin having a syndiotactic structure, a rubbery elastic material, an antioxidant selected from a phenol-based antioxidant and a sulfur-based antioxidant, a compound selected from a polyphenylene ether and a modified polyphenylene ether, and at least one kind selected from a nucleating agent and a release agent.

SPS is also useful as a household appliance material owing to the characteristics described above, and is considered to apply to tableware. For example, PTL 2 describes tableware for securing the heat resistance and the versatility and imparting aesthetic design easily, including a base molded article obtained by molding an SPS resin, and a paint coated on the surface thereof having been modified by irradiation of corona generated through corona discharge.

### CITATION LIST

### Patent Literatures

PTL 1: WO 2019/107526
PTL 2: JP 2015-217011 A

### SUMMARY OF INVENTION

### Technical Problem

A resin composition containing SPS has been investigated for applying to household appliances, such as tableware, owing to the excellent capabilities of SPS as described above. Another resin, such as an elastomer, has been blended for controlling the balance among the capabilities, and a colorant has been mixed for decorating the appearance. In the application to tableware, in particular, high aesthetic design has been demanded, and the suppression in color unevenness with a colorant and the enhancement in surface gloss have been demanded. In recent years, furthermore, tableware is frequently used in cooking with a microwave oven, along with the increased use of prepared foods available in convenience stores and instant foods, and there is a demand of decrease in transmission loss of electromagnetic waves, for efficiently heating the foods. Moreover, in the case where tableware is repeatedly used, there is a demand that the strength and the heat resistance of the tableware can be secured without melting the surface thereof even in the case where high oil content foods are heated to increase the temperature of the oil.

Accordingly, a problem to be solved by the present invention is to provide a styrene-based resin composition that has no color unevenness, excellent in gloss, and furthermore excellent in strength and heat resistance.

### Solution to Problem

As a result of the earnest investigations by the present inventors, it has been found that the problem can be solved by a resin composition that contains SPS, a styrene-based elastomer, a compatibilizer, an inorganic filler, and a colorant, and has particular values for the contents of the styrene-based elastomer and the colorant. Specifically, the present invention relates to the following items [1] to [19].

[1] A styrene-based resin composition containing a styrene-based resin (A) having a syndiotactic structure, a styrene-based elastomer (B), a compatibilizer (C), an inorganic filler (D), and a colorant (E), having a content of the styrene-based elastomer (B) of 2.0 to 30.0% by mass based on the total amount of the styrene-based resin (A) having a syndiotactic structure, the styrene-based elastomer (B) and the compatibilizer (C) as 100% by mass, and a content of the colorant (E) of 0.0001 to 6.5% by mass based on the entire amount of the styrene-based resin composition as 100% by mass.

[2] The styrene-based resin composition according to the item [1], wherein the styrene-based elastomer (B) is at least one kind selected from the group consisting of a styrene-diene block copolymer, a hydrogenated styrene-diene block copolymer, a styrene-diene random copolymer, a hydrogenated styrene-diene random copolymer, and a styrene-olefin random copolymer.

[3] The styrene-based resin composition according to the item [1] or [2], wherein the styrene-based elastomer (B) is at least one kind selected from the group consisting of a styrene-butadiene block copolymer, a hydrogenated styrene-butadiene block copolymer, a styrene-butadiene-styrene block copolymer, a hydrogenated styrene-butadiene-styrene block copolymer, a styrene-isoprene block copolymer, a hydrogenated styrene-isoprene block copolymer, a styrene-isoprene-styrene block copolymer, a hydrogenated styrene-isoprene-styrene block copolymer, a styrene-butadiene random copolymer, a hydrogenated styrene-butadiene random copolymer, a styrene-ethylene-propylene random copolymer, and a styrene-ethylene-butylene random copolymer.

[4] The styrene-based resin composition according to the item [2] or [3], wherein the styrene-based elastomer (B) has a mass ratio of a structural unit derived from styrene and the total of structural units derived from the diene, the hydrogenated diene, and the olefin ((styrene)/(diene, hydrogenated diene, olefin)) of 20/80 to 70/30.

[5] The styrene-based resin composition according to any one of the items [1] to [4], wherein the compatibilizer (C) is a modified polyphenylene ether.

[6] The styrene-based resin composition according to any one of the items [1] to [5], wherein the styrene-based resin composition has a content of the compatibilizer (C) of 0.4 to 5.0% by mass based on the total amount of the styrene-based resin (A) having a syndiotactic structure, the styrene-based elastomer (B), and the compatibilizer (C) as 100% by mass.

[7] The styrene-based resin composition according to any one of the items [1] to [6], wherein the inorganic filler (D) is a glass filler.

[8] The styrene-based resin composition according to any one of the items [1] to [7], wherein the styrene-based resin composition has a content of the inorganic filler (D) of 5 to 50% by mass based on the entire amount of the styrene-based resin composition as 100% by mass.

[9] The styrene-based resin composition according to any one of the items [1] to [8], wherein the inorganic filler (D) is treated with a silane-based coupling agent or a titanium-based coupling agent.

[10] The styrene-based resin composition according to any one of the items [1] to [9], wherein the colorant (E) is at least one kind selected from the group consisting of carbon black, an inorganic pigment, an organic pigment, and an organic dye.

[11] The styrene-based resin composition according to the item [10], wherein the inorganic pigment is at least one kind selected from the group consisting of titanium dioxide, iron oxide, nickel titanium yellow, zinc sulfide, barium sulfate, and ultramarine.

[12] The styrene-based resin composition according to the item [10], wherein the organic pigment is at least one kind selected from the group consisting of a monoazo pigment, a perylene pigment, a quinacridone pigment, and a phthalocyanine pigment.

[13] The styrene-based resin composition according to any one of the items [1] to [12], wherein the colorant (E) is at least one kind selected from the group consisting of carbon black, an inorganic pigment, an organic pigment, and an organic dye, and the styrene-based resin composition has a content of the colorant (E) of 0.0001% by mass or more, a content of the carbon black of 2.5% by mass or less, a content of the inorganic pigment of 3.0% by mass or less, and a total content of the organic pigment and the organic dye of 1.0% by mass or less, all based on the entire amount of the styrene-based resin composition as 100% by mass.

[14] The styrene-based resin composition according to any one of the items [1] to [13], wherein the styrene-based resin composition contains substantially no olefin-based elastomer.

[15] A resin molding material for tableware, containing the styrene-based resin composition according to any one of the items [1] to [14].

[16] A resin molding material for microwave oven cookware, containing the styrene-based resin composition according to any one of the items [1] to [14].

[17] A molded article containing the styrene-based resin composition according to any one of the items [1] to [14].

[18] Tableware containing the styrene-based resin composition according to any one of the items [1] to [14].

[19] Microwave oven cookware containing the styrene-based resin composition according to any one of the items [1] to [14].

### Advantageous Effects of Invention

The present invention can provide a styrene-based resin composition that has no color unevenness, excellent in gloss, and furthermore excellent in strength and heat resistance. Therefore, the styrene-based resin composition of the present invention is excellent particularly as a resin molding material for tableware.

### DESCRIPTION OF EMBODIMENTS

### [Styrene-Based Resin Composition]

The styrene-based resin composition of the present invention contains a styrene-based resin (A) having a syndiotactic structure, a styrene-based elastomer (B), a compatibilizer (C), an inorganic filler (D), and a colorant (E), the content of the styrene-based elastomer (B) is 2.0 to 30.0% by mass based on the total amount of the styrene-based resin (A) having a syndiotactic structure, the styrene-based elastomer (B) and the compatibilizer (C) as 100% by mass, and the content of the colorant (E) is 0.0001 to 6.5% by mass based on the entire amount of the styrene-based resin composition as 100% by mass.

The respective items will be described in detail below.

In the description herein, “x to y” means a numerical range of “x or more and y or less”. The upper limit values and the lower limit values described for the numerical ranges may be optionally combined. Among the embodiments relating to the present invention described below, two or more embodiments that are not contradictory to each other may be combined, and an embodiment including two or more embodiments is also an embodiment relating to the present invention.

### <Styrene-Based Resin (A) Having Syndiotactic Structure>

The styrene-based resin (A) (which may be hereinafter referred to as SPS (A)) is a styrene-based resin having a highly syndiotactic structure. In the description herein, the term “syndiotactic” means a high proportion of the phenyl rings of the styrene units adjacent to each other that are alternately arranged with respect to the plane constituted by the main chain of the polymer block (which may be hereinafter referred to as syndiotacticity).

The tacticity can be quantitatively identified by the nuclear magnetic resonance method using isotope carbon (i.e., the ¹³C-NMR method). The existing proportions of continuous plural constitutional units, for example, continuous two monomer units as a diad, continuous three monomer units as a triad, and continuous five monomer units as a pentad, can be quantitatively identified by the ¹³C-NMR method.

In the present invention, the “styrene-based resin having a highly syndiotactic structure” means a styrene-based polymer, such as a polystyrene, a poly(hydrocarbon-substituted styrene), a poly(halostyrene), a poly(haloalkylstyrene), a poly(alkoxystyrene), a poly(vinyl benzoate ester), a hydrogenated polymer or a mixture thereof, and a copolymer having these as a major component, each having a racemic diad (r) fraction of generally 75% by mol or more, and preferably 85% by mol or more, or having a racemic pentad (rrrr) fraction of generally 30% by mol or more, and preferably 50% by mol or more.

Examples of the poly(hydrocarbon-substituted styrene) include poly(methylstyrene), poly(ethylstyrene), poly(isopropylstyrene), poly(tert-butylstyrene), poly(phenylstyrene), poly(vinylnaphthalene), and poly(vinylstyrene). Examples of the poly(halostyrene) include poly(chlorostyrene), poly(bromostyrene), and poly(fluorostyrene), and examples of the poly(haloalkylstyrene) include poly(chloromethylstyrene). Examples of the poly(alkoxystyrene) include poly(methoxystyrene) and poly(ethoxystyrene).

Examples of the comonomer component of the copolymer containing the aforementioned constitutional units include the monomers of the aforementioned styrene polymers, and also include an olefin monomer, such as ethylene, propylene, butene, hexene, and octene; a diene monomer, such as butadiene and isoprene; a cyclic olefin monomer; a cyclic diene monomer; and a polar vinyl monomers, such as methyl methacrylate, maleic anhydride, and acrylonitrile.

Examples of the copolymer that is preferably used as the styrene-based resin (A) include a copolymer of styrene and p-methylstyrene, a copolymer of styrene and p-tert-butylstyrene, and a copolymer of styrene and divinylbenzene, and a copolymer of styrene and p-methylstyrene is preferred.

The styrene-based resin is preferably at least one kind selected from polystyrene, poly(p-methylstyrene), poly(m-methylstyrene), poly(p-tert-butylstyrene), poly(p-chlorostyrene), poly(m-chlorostyrene), poly(p-fluorostyrene), and a copolymer of styrene and p-methylstyrene, more preferably at least one kind selected from polystyrene, poly(p-methylstyrene), poly(m-methylstyrene), and a copolymer of styrene and p-methylstyrene, further preferably at least one kind selected from polystyrene and a copolymer of styrene and p-methylstyrene, and most preferably polystyrene.

The melt flow rate (MFR) of the SPS (A) measured under condition of a temperature of 300° C. and a load of 1.2 kg is preferably 2 g/10 min or more, and more preferably 4 g/10 min or more, and is preferably 50 g/10 min or less, and more preferably 35 g/10 min or less. In the case where the MFR value of the SPS (A) is 2 g/10 min or more, there is no problem in the flowability of the resin in molding, and in the case where the MFR value thereof is 50 g/10 min or less, and more preferably 35 g/10 min or less, a molded article having a sufficient strength can be obtained.

The weight average molecular weight of the SPS (A) is preferably 1×10⁴ or more and 1×10⁶ or less, more preferably 50,000 or more and 500,000 or less, and further preferably 50,000 or more and 200,000 or less, from the standpoint of the flowability of the resin in molding and the strength of the resulting molded article. In the case where the weight average molecular weight is 1×10⁴ or more, a molded article having a sufficient strength can be obtained. In the case where the weight average molecular weight is 1×10⁶ or less, there is no problem in the flowability of the resin in molding.

In the description herein, unless there is any particular description, the weight average molecular weight is a value that is obtained by measuring by the gel permeation chromatography method using a GPC apparatus (HLC-8321 GPC/HT), available from Tosoh Corporation, a GPC column (GMHHR-H(S)HTC/HT), available from Tosoh Corporation, and 1,2,4-trichlorobenzene as an eluent, at 145° C., and converting with the standard polystyrene calibration curve.

The SPS (A) can be produced, for example, by polymerizing a styrene-based monomer (i.e., a monomer corresponding to the styrene-based polymer) using a titanium compound and a condensation product of a trialkylaluminum with water (aluminoxane) as a catalyst, in an inert hydrocarbon solvent or in the absence of a solvent (see, for example, JP 2009-068022 A).

The content of the styrene-based resin (A) having a syndiotactic structure (SPS (A)) in the styrene-based resin composition is preferably 65 to 97.6% by mass, more preferably 78 to 97.6% by mass, further preferably 82 to 97.6% by mass, and still further preferably 85.5 to 97.6% by mass, based on the total amount of the styrene-based resin (A) having a syndiotactic structure, the styrene-based elastomer (B), and the compatibilizer (C) as 100% by mass.

### <Styrene-Based Elastomer (B)>

The styrene-based resin composition of the present invention contains a styrene-based elastomer (B). The content of the styrene-based elastomer (B) is 2.0 to 30.0% by mass based on the total amount of the styrene-based resin (A) having a syndiotactic structure, the styrene-based elastomer (B), and the compatibilizer (C) as 100% by mass.

The styrene-based elastomer (B) contained in the styrene-based resin composition of the present invention can suppress the color unevenness and can enhance the strength significantly since the styrene-based elastomer (B) has high compatibility with the SPS (A).

The styrene-based elastomer (B) is not particularly limited, as far as being an elastomer containing a structural unit derived from styrene, and is preferably at least one kind selected from the group consisting of a styrene-diene block copolymer, a hydrogenated styrene-diene block copolymer, a styrene-diene random copolymer, a hydrogenated styrene-diene random copolymer, and a styrene-olefin random copolymer. Examples of the diene copolymerized with styrene herein include butadiene and isoprene, and examples of the olefin copolymerized with styrene herein include ethylene, propylene, and butylene.

The styrene-based elastomer (B) is more preferably at least one kind selected from the group consisting of a styrene-butadiene block copolymer (SBR), a hydrogenated styrene-butadiene block copolymer (SEB), a styrene-butadiene-styrene block copolymer (SBS), a hydrogenated styrene-butadiene-styrene block copolymer (SEBS), a styrene-isoprene block copolymer (SIR), a hydrogenated styrene-isoprene block copolymer (SEP), a styrene-isoprene-styrene block copolymer (SIS), a hydrogenated styrene-isoprene-styrene block copolymer (SEPS), a styrene-butadiene random copolymer, a hydrogenated styrene-butadiene random copolymer, a styrene-ethylene-propylene random copolymer, and a styrene-ethylene-butylene random copolymer, further preferably at least one kind selected from the group consisting of a styrene-butadiene block copolymer (SBR), a hydrogenated styrene-butadiene block copolymer (SEB), a styrene-butadiene-styrene block copolymer (SBS), a hydrogenated styrene-butadiene-styrene block copolymer (SEBS), a styrene-isoprene block copolymer (SIR), a hydrogenated styrene-isoprene block copolymer (SEP), a styrene-isoprene-styrene block copolymer (SIS), and a hydrogenated styrene-isoprene-styrene block copolymer (SEPS), still further preferably at least one kind selected from the group consisting of a styrene-butadiene-styrene block copolymer (SBS), a hydrogenated styrene-butadiene-styrene block copolymer (SEBS), a styrene-isoprene-styrene block copolymer (SIS), and a hydrogenated styrene-isoprene-styrene block copolymer (SEPS), still more further preferably at least one kind selected from the group consisting of a hydrogenated styrene-butadiene-styrene block copolymer (SEBS), a styrene-isoprene-styrene block copolymer (SIS), and a hydrogenated styrene-isoprene-styrene block copolymer (SEPS), and even further preferably a hydrogenated styrene-butadiene-styrene block copolymer (SEBS).

The mass ratio of the structural unit derived from styrene and the total of the structural units derived from the diene, the hydrogenated diene, and the olefin constituting the styrene-based elastomer (B) ((styrene)/(diene, hydrogenated diene, olefin)) is preferably 20/80 to 70/30, more preferably 25/75 to 60/40, and further preferably 25/75 to 45/55. The content of styrene in the styrene-based elastomer (B) is preferably 20 to 70% by mass, more preferably 25 to 60% by mass, and further preferably 25 to 45% by mass, based on the styrene-based elastomer (B).

In the case where the content of styrene or the mass ratio of the structural unit derived from styrene and the total of the structural units derived from the diene, the hydrogenated diene, and the olefin is in the range, the compatibility with the SPS (A) can be enhanced, the color unevenness can be suppressed, and the strength can be significantly enhanced.

The content of the styrene-based elastomer (B) in the styrene-based resin composition is 2.0 to 30.0% by mass based on the total amount of the styrene-based resin (A) having a syndiotactic structure, the styrene-based elastomer (B) and the compatibilizer (C) as 100% by mass. In the case where the amount of the styrene-based elastomer (B) is 2.0% by mass or more, the mechanical strength of the resulting resin composition can be enhanced, and in the case where the amount of the styrene-based elastomer (B) is 30.0% by mass or less, the heat resistance of the resulting resin composition can be improved.

The content of the styrene-based elastomer (B) is preferably 2.0 to 18.0% by mass, more preferably 2.0 to 15.0% by mass, further preferably 2.0 to 12.0% by mass, still further preferably 4.0 to 12.0% by mass, and still more further preferably 7.0 to 11.0% by mass, based on the total amount of the styrene-based resin (A) having a syndiotactic structure, the styrene-based elastomer (B) and the compatibilizer (C) as 100% by mass.

The styrene-based resin composition of the present invention preferably has a smaller content of an olefin-based elastomer, and more preferably contains substantially no olefin-based elastomer.

In the olefin-based elastomer, the content of an ethylene-octene copolymer is preferably smaller, and it is more preferred that substantially no ethylene-octene copolymer is contained.

The content of the olefin-based elastomer is preferably 25% by mass or less, more preferably 15% by mass or less, further preferably 5% by mass or less, and still further preferably 0% by mass, based on the total amount of the styrene-based resin (A) having a syndiotactic structure, the styrene-based elastomer (B) and the compatibilizer (C) as 100% by mass. In the case where substantially no olefin-based elastomer is contained, the dispersibility of the colorant (E) in the styrene-based resin composition can be enhanced, and the color unevenness can be suppressed.

### <Compatibilizer (C)>

The styrene-based resin composition of the present invention contains a compatibilizer (C).

It is preferred that the compatibilizer (C) used in the styrene-based resin composition of the present invention has compatibility with the styrene-based resin (A), enhances the compatibility thereof with the other components, and has a polar group capable of reacting with the inorganic filler (D).

The compatibilizer (C) is blended for the purpose of enhancing the compatibility between the SPS (A) and the other components, particularly the inorganic filler (D), and enhancing the interface strength among the components.

The compatibilizer (C) has compatibility with the SPS (A), and the structure thereof that contributes to the compatibility is preferably a structure containing a chain having compatibility with the SPS in the polymer chain.

Examples thereof include a structure having polystyrene, polyphenylene ether, polyvinyl methyl ether, or the like as the main chain or the graft chain of the polymer chain, and a polyphenylene ether structure is preferred.

The polar group capable of reacting with the inorganic filler (D) means a functional group capable of reacting with the polar group of the inorganic filler (D). Specific examples thereof include an acid anhydride group, a carboxylic acid group, a carboxylic acid ester group, a carboxylic acid halide group, a carboxylic acid amide group, a carboxylate group, a sulfonic acid group, a sulfonic acid ester group, a sulfonic acid chloride group, a sulfonic acid amide group, a sulfonate group, an epoxy group, an amino group, an imido group, and an oxazoline group, and a carboxylic acid group is preferred.

Examples of the compatibilizer (C) include a modified polyphenylene ether and the like, and a modified polyphenylene ether is preferred.

Examples of the modified polyphenylene ether include fumaric acid-mollified polyphenylene ether, maleic anhydride-modified polyphenylene ether, a (styrene-maleic anhydride)-polyphenylene ether graft polymer, glycidyl methacrylate-modified polyphenylene ether, and amine-modified polyphenylene ether, in which fumaric acid-modified polyphenylene ether and maleic anhydride-mollified polyphenylene ether are preferred, and fumaric acid-modified polyphenylene ether is more preferred.

The modification amount (modifier content) of the modified polyphenylene ether is preferably 0.1 to 20% by mass, more preferably 0.2 to 15% by mass, further preferably 0.3 to 10% by mass, and still further preferably 0.5 to 5.0% by mass. In the case where the modification amount is in the range, a styrene-based resin composition and a molded article having favorable strength and heat resistance can be obtained.

The modification amount (modifier content) of the modified polyphenylene ether can be obtained from a neutralization titer measured according to JIS K0070-1992.

The modified polyphenylene ether can be obtained by modifying a known polyphenylene ether with a modifier, but the method for obtaining the modified polyphenylene ether is not limited to the method, as far as the product can be used for the purpose of the present invention. The polyphenylene ether is a known compound, and reference may be made for the purpose to U.S. Pat. Nos. 3,306,874, 3,306,875, 3,257,357, and 3,257,358. The polyphenylene ether is generally prepared through oxidative coupling reaction using a di- or tri-substituted phenol in the presence of a copper-amine complex catalyst. The copper-amine complex used may be a copper-amine complex derived from a primary, secondary, or tertiary amine.

Examples of the polyphenylene ether include poly(2,6-dimethyl-1,4-phenylene ether), poly(2,3-dimethyl-6-ethyl-1,4-phenylene ether), poly(2-methyl-6-chloromethyl-1,4-phenylene ether), poly(2-methyl-6-hydroxyethyl-1,4-phenylene ether), poly(2-methyl-6-n-butyl-1,4-phenylene ether), poly(2-ethyl-6-isopropyl-1,4-phenylene ether), poly(2-ethyl-6-n-propyl-1,4-phenylene ether), poly(2,3,6-trimethyl-1,4-phenylene ether), poly[2-(4′-methylphenyl)-1,4-phenylene ether], poly(2-bromo-6-phenyl-1,4-phenylene ether), poly(2-methyl-6-phenyl-1,4-phenylene ether), poly(2-phenyl-1,4-phenylene ether), poly(2-chloro-1,4-phenylene ether), poly(2-methyl-1,4-phenylene ether), poly(2-chloro-6-ethyl-1,4-phenylene ether), poly(2-chloro-6-bromo-1,4-phenylene ether), poly(2,6-di-n-propyl-1,4-phenylene ether), poly(2-methyl-6-isopropyl-1,4-phenylene ether), poly(2-chloro-6-methyl-1,4-phenylene ether), poly(2-methyl-6-ethyl-1,4-phenylene ether), poly(2,6-dibromo-1,4-phenylene ether), poly(2,6-dichloro-1,4-phenylene ether), and poly(2,6-diethyl-1,4-phenylene ether), and poly(2,6-dimethyl-1,4-phenylene ether) is preferred.

Examples of the modifier used for modifying the polyphenylene ether include a compound having an ethylenic double bond and a polar group in one molecule, and specific examples thereof include maleic anhydride, maleic acid, fumaric acid, a maleic acid ester, a fumaric acid ester, maleimide and an N-substituted derivative thereof, a maleic acid salt, a fumaric acid salt, acrylic acid, an acrylic acid ester, acrylamide, an acrylic acid salt, methacrylic acid, a methacrylic acid ester, methacrylamide, a methacrylic acid salt, and glycidyl methacrylate. Among these, maleic anhydride, fumaric acid, and glycidyl methacrylate are preferably used, and fumaric acid is more preferably used. One kind of the modifier may be used alone, or two or more kinds thereof may be used in a combination.

The modified polyphenylene ether can be obtained by reacting the polyphenylene ether and the modifier. The method of modification is not particularly limited, and a known method may be used.

Examples of the preferred modification method include melt modification and solution modification, and melt modification is more preferred since a high modification amount can be obtained, and a high productivity can be obtained. Accordingly, the modified polyphenylene ether is preferably a modified polyphenylene ether that is produced through melt modification or a modified polyphenylene ether that is produced through solution modification, and more preferably a modified polyphenylene ether that is produced through melt modification.

The melt modification is a method of melting and kneading the polyphenylene ether and the modifier in the presence or absence of a radical generator, so as to provide the modified polyphenylene ether, and may be specifically a method of reacting by melting and kneading at a temperature in a range of 150 to 350° C. with a roll mill, a Banbury mixer, an extruder, or the like.

Specifically, a preferred method therefor may include dry blending the polyphenylene ether, the modifier, and optionally a radical generator uniformly at room temperature, and performing a melting reaction in a range of 300 to 350° C., which is substantially the kneading temperature for the polyphenylene ether. With a temperature of 300° C. or more, melting viscosity can be appropriately retained, and with a temperature of 350° C. or less, the polyphenylene ether can be suppressed from being decomposed.

The amount of the modifier used in the melt modification is preferably 0.1 to 22 parts by mass, more preferably 0.2 to 17 parts by mass, further preferably 0.3 to 12 parts by mass, and still further preferably 0.5 to 7.0 parts by mass, per 100 parts by mass of the polyphenylene ether. In the case where the amount of the modifier used is in the range, a styrene-based resin composition and a molded article having favorable strength and heat resistance can be obtained.

The radical generator used in the melt modification preferably has a temperature exhibiting a half period of 1 minute of 300° C. or more, and specific examples thereof include 2,3-dimethyl-2,3-diphenylbutane, 2,3-diethyl-2,3-diphenylbutane, 2,3-diethyl-2,3-diphenylhexane, and 2,3-dimethyl-2,3-di(p-methylphenyl)butane, in which 2,3-dimethyl-2,3-diphenylbutane exhibiting a half period of 1 minute of 330° C. is preferably used.

The proportion of the radical generator used is preferably selected from 0.1 to 3 parts by mass, and more preferably 0.5 to 2 parts by mass, per 100 parts by mass of the polyphenylene ether. With a proportion of 0.1 part by mass or more, a high modification effect can be obtained, and with a proportion of 3 parts by mass or less, the polyphenylene ether can be efficiently modified, and insoluble components are hardly generated.

The content of the compatibilizer (C) in the styrene-based resin composition of the present invention is preferably 0.4 to 5.0% by mass based on the total amount of the styrene-based resin (A) having a syndiotactic structure, the styrene-based elastomer (B), and the compatibilizer (C) as 100% by mass. In the case where the amount of the compatibilizer (C) is 0.4% by mass or more, the resulting resin composition can have excellent mechanical strength. In the case where the amount of the compatibilizer (C) is 5.0% by mass or less, the amount of foreign matters in the resulting resin composition can be reduced, and the good appearance of the molded article obtained from the resin composition can be retained.

The content of the compatibilizer (C) is more preferably 0.4 to 4.0% by mass, further preferably 0.4 to 3.0% by mass, still further preferably 0.4 to 2.5% by mass, still more further preferably 0.4 to 1.7% by mass, and even further preferably 0.4 to 0.7% by mass, based on the total amount of the styrene-based resin (A) having a syndiotactic structure, the styrene-based elastomer (B), and the compatibilizer (C) as 100% by mass.

### <Inorganic Filler (D)>

The styrene-based resin composition of the present invention contains an inorganic filler (D).

Examples of the form of the inorganic filler (D) include a fibrous form, a granular form, and a powder form. A fibrous filler is preferably used from the standpoint of the achievement of an excellent strength.

Examples of the inorganic filler (D) include a glass filler and a ceramic filler, and a glass filler is preferred.

The glass filler is more preferably at least one kind selected from glass fibers, glass powder, glass flakes, milled fibers, glass cloth, and glass beads, and further preferably glass fibers since an excellent mechanical strength can be obtained. The use of glass fibers can enhance the strength and the heat resistance of the styrene-based resin composition and the molded article, and the styrene-based resin composition can be favorably applied to a resin molding material for tableware.

The length of the glass fibers is preferably 0.05 to 50 mm, and more preferably 0.05 to 10 mm, from the standpoint of the handleability. With the length within the range, furthermore, the length of the glass fibers becomes approximately from 0.01 mm to 1.0 mm after forming the molded article, resulting in excellent gloss thereof. The diameter of the glass fibers is preferably 5 to 20 μm.

Examples of the ceramic filler include talc, titanium dioxide, mica, boron, alumina, calcium carbonate, silica, silicon carbide, gypsum, potassium titanate, calcium sulfate, barium carbonate, magnesium sulfate, barium sulfate, magnesium oxide, and kaolin.

Examples of the form of the ceramic filler include a fibrous form, a granular form, and a powder form.

The inorganic filler (D) used may be a combination of a glass filler and a ceramic filler.

The inorganic filler (D) is preferably surface-treated with a coupling agent, and more preferably with a silane-based coupling agent or a titanium-based coupling agent, for enhancing the adhesiveness thereof to the SPS (A), and is further preferably treated with a silane-based coupling agent from the standpoint of the compatibility with the resin component.

Specific examples of the silane coupling agent include triethoxysilane, vinyltris(β-methoxyethoxy)silane, γ-methacryloxypropyltrimethoxysilane, γ-glycidoxypropyltrimethoxysilane, β-(1,1-epoxycyclohexyl)ethyltrimethoxy silane, N-β-(aminoethyl)-γ-aminopropyltrimethoxysilane, N-β-(aminoethyl)-γ-aminopropylmethyldimethoxysilane, γ-aminopropyltriethoxysilane, N-phenyl-γ-aminopropyltrimethoxysilane, γ-mercaptopropyltrimethoxysilane, γ-chloropropyltrimethoxysilane, γ-aminopropyltrimethoxysilane, γ-aminopropyl-tris(2-methoxy-ethoxy)silane, N-methyl-γ-aminopropyltrimethoxysilane, N-vinylbenzyl-γ-aminopropyl triethoxysilane, 3-ureidopropyltrimethoxysilane, 3-4,5-dihydroimidazole-propyltriethoxysilane, hexamethyldisilazane, N,N-bis(trimethylsilyl)urea, and 3-triethoxysilyl-N-(1,3-dimethylbutylidene)propylamine. Among these, an aminosilane and an epoxysilane, such as γ-aminopropyltrimethoxysilane, N-β-(aminoethyl)-γ-aminopropyltrimethoxysilane, γ-glycidoxypropyltrimethoxy silane and 8-(3,4-epoxycyclohexyl)ethyltrimethoxysilane, are preferred.

Specific examples of the titanium coupling agent include isopropyltriisostearoyl titanate, isopropyltridodecylbenzenesulfonyl titanate, isopropyltris(dioctylpyrophosphate) titanate, tetraisopropylbis (clioctylphosphite) titanate, tetraoctylbis(clitridecylphosphite) titanate, tetra(1,1-diallyloxymethyl-1-butyl)bis(ditridecyl)phosphite titanate, bis(clioctylpyrophosphate)oxyacetate titanate, bis(dioctylpyrophosphate)ethylene titanate, isopropyltrioctanoyl titanate, isopropyldimethacrylisostearoyl titanate, isopropylisostearoyldiacryl titanate, isopropyltri(dioctylphosphate) titanate, isopropyltricumylphenyl titanate, isopropyltri(N-amidoethyl, aminoethyl) titanate, dicumylphenyloxyacetate titanate, and diisostearoylethylene titanate. Among these, isopropyltri(N-amidoethyl, aminoethyl) titanate is preferred.

The surface treatment of the inorganic filler with the coupling agent can be performed by any known ordinary method. Examples of the method include a sizing treatment of coating an organic solvent solution or a suspension liquid of the coupling agent, a dry mixing treatment, a spraying method, an integral blending method, and a dry concentrating method, and a sizing treatment, a dry mixing treatment, and a spraying method are preferred.

The content of the inorganic filler (D) in the styrene-based resin composition is preferably 5 to 50% by mass based on the entire amount of the styrene-based resin composition as 100% by mass. In the case where the amount of the inorganic filler (D) is 5% by mass or more, a sufficient release stiffness can be obtained. In the case where the amount of the inorganic filler (D) is 50% by mass or less, the mechanical properties and the glossiness of the styrene-based resin composition are not adversely affected thereby.

The content of the inorganic filler (D) is more preferably 5 to 40% by mass, further preferably 5 to 35% by mass, and still further preferably 5 to 20% by mass, based on the entire amount of the styrene-based resin composition as 100% by mass.

### <Colorant (E)>

The styrene-based resin composition of the present invention contains a colorant (E), and the content of the colorant (E) is 0.0001 to 6.5% by mass based on the entire amount of the styrene-based resin composition as 100% by mass.

In the case where the content of the colorant (E) is 0.0001% by mas or more, the resulting resin composition can have good coloration, and in the case where the amount of the colorant (E) is 6.5% by mass or less, there may be no concern of adverse effects on the human body even if the colorant is transferred to foods through elution or exudation depending on the use condition in the application to products in contact with foods. The colorant (E) contained in the aforementioned amount can provide excellent moldability of the styrene-based resin composition of the present invention. Furthermore, a molded article obtained with the styrene-based resin composition is reduced in influence of color unevenness, and is excellent in aesthetic design.

From the aforementioned standpoint, the content of the colorant (E) is preferably 0.0001% by mass or more and 3.0% by mass or less, more preferably 0.01% by mass or more and 2.5% by mass or less, further preferably 0.1% by mass or more and 1.0% by mass or less, and still further preferably 0.1% by mass or more and 0.4% by mass or less, based on the entire amount of the styrene-based resin composition as 100% by mass.

The colorant (E) may be at least one kind selected from the group consisting of carbon black, an inorganic colorant, and an organic colorant. Examples of the inorganic colorant include an inorganic pigment, and examples of the organic colorant include an organic pigment and an organic dye.

Accordingly, the colorant (E) is preferably at least one kind selected from the group consisting of carbon black, an inorganic pigment, an organic pigment, and an organic dye.

Among these, carbon black is more preferred in the case where a black resin composition is to be obtained.

The inorganic pigment is preferably at least one kind selected from the group consisting of titanium dioxide, iron oxide, nickel titanium yellow, zinc sulfide, barium sulfate, and ultramarine.

The organic pigment is preferably at least one kind selected from the group consisting of a monoazo pigment, a perylene pigment, a quinacridone pigment, and a phthalocyanine pigment. Preferred specific examples of the organic pigment include a monoazo pigment, such as Pigment Yellow 183 and Pigment Yellow 150, a perylene pigment, such as Pigment Red 178 and Pigment Red 149, a quinacridone pigment, such as Pigment Violet 19, Pigment Red 122, Pigment Red 209, Pigment Red 202, Pigment Orange 48, and Pigment Orange 49, and a phthalocyanine pigment, such as Pigment Blue 15, Pigment Blue 16, Pigment Green 7, and Pigment Green 36.

The content of the colorant (E) may be appropriately regulated depending on the appearance of the molded article and the product obtained with the styrene-based resin composition of the present invention. The content thereof may also be appropriately regulated within the aforementioned range depending on the extent of coloration of the colorant since the extent of coloration varies depending on the kind of the colorant.

In the case where the colorant (E) is at least one kind selected from carbon black, an inorganic pigment, an organic pigment, and an organic dye, the content of the colorant (E) is preferably 0.0001% by mass or more, in which the content of the carbon black is preferably 2.5% by mass or less, the content of the inorganic pigment is preferably 3.0% by mass or less, and the total of the contents of the organic pigment and the organic dye is preferably 1.0% by mass or less, all based on the entire amount of the styrene-based resin composition as 100% by mass.

Accordingly, in the case where the colorant (E) is at least one kind selected from carbon black, an inorganic pigment, an organic pigment, and an organic dye, the total of the contents of the carbon black, the inorganic pigment, the organic pigment, and the organic dye is preferably 0.0001% by mass or more and 6.5% by mass or less, in which the content of the carbon black is preferably 0% by mass or more and 2.5% by mass or less, the content of the inorganic pigment is preferably 0% by mass or more and 3.0% by mass or less, and the total of the contents of the organic pigment and the organic dye is preferably 0% by mass or more and 1.0% by mass or less, all based on the entire amount of the styrene-based resin composition as 100% by mass.

In the case where carbon black is used as the colorant (E), the content of the carbon black is preferably 0.0001% by mass or more and 2.5% by mass or less, more preferably 0.01% by mass or more and 1.8% by mass or less, further preferably 0.1% by mass or more and 1.0% by mass or less, and still further preferably 0.1% by mass or more and 0.4% by mass or less, based on the entire amount of the styrene-based resin composition as 100% by mass.

Multiple kinds of the colorants may be used in combination depending on necessity.

A commercially available product may also be favorably used as the colorant (E). Examples of the commercially available product of the carbon black include MONARCH 800, Black Pearls 800, and Black Pearls 4350 (all available from Cabot Corporation). Examples of the commercially available product of the titanium dioxide include CR-60 (available from Ishihara Sangyo Kaisha, Ltd.). Examples of the commercially available product of the iron oxide include Toda Color 120ED (available from Toda Kogyo Corporation). Examples of the commercially available product of the ultramarine include Ultramarine #8000 (available from Daiichi-Kasei Co., Ltd.). Examples of the commercially available product of the monoazo pigment include Paliotol Yellow K1800 (available from BASF SE). Examples of the commercially available product of the perylene pigment include PV Fast Red B (available from Clariant AG). Examples of the commercially available product of the quinacridone pigment include Cinqasia Mazenta k4535FP (available from BASF SE).

### <Additional Component>

The styrene-based resin composition of the present invention may optionally contain an additional component in such a range that does not impair the object of the present invention.

Specifically, the styrene-based resin composition of the present invention may contain, as an additional component, an antioxidant, a crosslinking agent, a crosslinking aid, a crystallization nucleating agent, a dispersant, a plasticizer, a release agent, an antifouling agent, an ultraviolet ray absorbent, a light stabilizer, a flame retardant, a flame retarding aid, and an antistatic agent, which are optional components.

The antioxidant used is preferably one or more kind selected from a phenol-based compound, a phosphorus-based compound, and a sulfur-based compound, and a phenol-based compound is more preferred from the standpoint of the heat resistance.

Examples of the phenol-based antioxidant include 2,6-cli-tert-butyl-4-methylphenol, 2,6-diphenyl-4-methoxyphenol, 2,2′-methylenebis(6-tert-butyl-4-methylphenol), 2,2′-methylenebis[4-methyl-6-(α-methylcyclohexyl)phenol], 1,1-bis(5-tert-butyl-4-hydroxy-2-methylphenyl)butane, 2,2′-methylenebis(4-methyl-6-cyclohexylphenol), 2,2′-methylenebis(4-methyl-6-nonylphenol), 1,1,3-tris(5-tert-butyl-4-hydroxy-2-methylphenyl)butane, 2,2-bis(5-tert-butyl-4-hydroxy-2-methylphenyl)-4-n-dodecylmercaptobutane, ethylene glycol bis[3,3-bis(3-tert-butyl-4-hydroxyphenyl)butyrate], 1,1-bis(3,5-dimethyl-2-hydroxyphenyl)-3-(n-dodecylthio)butane, 4,4′-thiobis(6-tert-butyl-3-methylphenol), 1,3,5-tris(3,5-di-tert-butyl-4-hydroxybenzyl)-2,4,6-trimethylbenzene, dioctadecyl 2,2-bis(3,5-di-tert-butyl-4-hydroxybenzyl)malonate, n-octadecyl-3-(4-hydroxy-3,5-di-tert-butylphenyl)propionate, and pentaerythritol tetrakis{3-(3,5-di-tert-butyl-4-hydroxyphenyl)propionate}. In particular, pentaerythritol tetrakis{3-(3,5-di-tert-butyl-4-hydroxyphenyl)propionate} is preferred.

Examples of the phosphorus-based compound include a monophosphite and a diphosphite, such as tris(2,4-di-tert-butylphenyl) phosphite and tris(mono- or dinonylphenyl) phosphite.

As for the content of the antioxidant in the styrene-based resin composition of the present invention, the content of the antioxidant is preferably 0.05 part by mass or more, more preferably 0.1 part by mass or more, and further preferably 0.15 part by mass or more, per 100 parts by mass of the total amount of the styrene-based resin (A) having a syndiotactic structure, the styrene-based elastomer (B), and the compatibilizer (C). The content thereof is preferably 2.0 parts by mass or less, more preferably 1.0 part by mass or less, and further preferably 0.7 part by mass or less. In the case where the amount of the antioxidant is in the range, the heat resisting discoloration resistance in working can be improved, long-term heat resistance can also be obtained, the antioxidant can be suppressed from bleeding, and the appearance can be prevented from being adversely affected.

The styrene-based resin composition of the present invention preferably contains a crystallization nucleating agent.

The crystallization nucleating agent is preferably one or more kind selected from the group consisting of an inorganic crystallization nucleating agent and an organic crystallization nucleating agent. Among these, an organic crystallization nucleating agent is preferred.

Examples of the organic crystallization nucleating agent include an alkali metal salt of an organic carboxylic acid, an alkaline earth metal salt of an organic carboxylic acid, an organic compound of phosphoric acid or phosphorous acid and a metal salt thereof, a phthalocyanine derivative, and a sorbitol derivative.

More specifically, a known compound may be optionally selected and used, for example, a metal salt of a carboxylic acid, such as aluminum di(p-tert-butylbenzoate), sodium benzoate, a hydroxyaluminum salt of p-tert-butyl benzoate, and aluminum hydroxydi(p-tert-butyl benzoate), a metal salt of phosphoric acid, such as sodium methylenebis(2,4-di-tert-butylphenol)phosphate, sodium 2,2′-methylenebis(4,6-cli-tert-butylphenyl)phosphate, lithium ([2,2′-methylenebis(4,6-di-tert-butylphenyl)phosphate]), potassium ([2,2 ‘-methylenebis(4,6-di-tert-butylphenyl)phosphate]), sodium bis(4-tert-butylphenyl)phosphate, sodium methylene(2,4-tert-butylphenyl)phosphate, and aluminum bis(4,6’,6,6′-tetra-tert-butyl-2,2′-methylenediphenyl phosphate) hydroxide, and ammonium [(2,2′-methylenebis(4,6-di-tert-butylphenyl)]phosphate). A composite material containing these compounds may also be used.

As for the content of the crystallization nucleating agent in the styrene-based resin composition of the present invention, the content of the crystallization nucleating agent is preferably 0.01 part by mass or more, more preferably 0.1 part by mass or more, and further preferably 0.15 part by mass or more, per 100 parts by mass of the total amount of the styrene-based resin (A) having a syndiotactic structure, the styrene-based elastomer (B), and the compatibilizer (C). The content thereof is preferably 2.0 parts by mass or less, more preferably 1.0 part by mass or less, and further preferably 0.7 part by mass or less. The use of the crystallization nucleating agent can enhance the effects of the present invention, and a composition having no color unevenness, excellent in gloss and also excellent in strength and heat resistance can be obtained.

The styrene-based resin composition of the present invention preferably contains a release agent.

The release agent use may be optionally selected from known ones, such as polyethylene wax, a silicone oil, and a long-chain carboxylic acid. Among these, a silicone oil is preferred.

As for the content of the release agent in the styrene-based resin composition of the present invention, the content of the release agent is preferably 0.05 to 3.0% by mass, preferably 0.1 to 2.0% by mass, preferably 0.1 to 1.0% by mass, and preferably 0.1 to 0.5% by mass, based on the entire amount of the styrene-based resin composition as 100% by mass. The use of the release agent can enhance the effects of the present invention, and a molded article suppressed in color unevenness and excellent in gloss can be obtained.

The dispersant used may be optionally selected from known ones, such as methylenebisstearic acid amide, polyacrylic acid, sodium polyacrylate, a sodium carboxylate, ammonium polyacrylate, a polyacrylate-based copolymer, a sodium polycarboxylate, a carboxylic acid-based copolymer, and a sulfonic acid-based copolymer.

The ultraviolet ray absorbent used may be selected from known ones, such as 2-(2H-benzotriazol-2-yl)-4,6-bis(1-methyl-1-phenylethyl)phenol, 2-(2H-benzotriazol-2-yl)-4-(1,1,3,3-tetramethylbutyl)phenol, 2,2′-methylenebis[6-(2H-benzotriazol-2-yl)-4-(1,1,3,3-tetramethylbutyl)phenol], 2-(2H-benzotriazol-2-yl)-p-cresol, 2-(5-chloro-2H-benzotriazol-2-yl)-6-tert-butyl-4-methylphenol, 2-(4,6-diphenyl-1,3,5-triazin-2-yl)-5-[2-(2-ethylhexanoyloxy)ethoxy]phenol, 2,4,6-tris (2-hydroxy-4-hexyloxy-3-methylphenyl)-1,3,5-triazine, and [2-hydroxy-4-(octyloxy)phenyl](phenyl)methanone.

The light stabilizer used may be selected from known ones, such as tetrakis(1,2,2,6,6-pentamethyl-4-piperidyl)butane-1,2,3,4-tetracarboxylate, tetrakis(2,2,6,6-tetramethyl-4-piperidyl)butane-1,2,3,4-tetracarboxylate, 1,2,3,4-butanetetracarboxylic acid, tetramethyl ester, reaction products with 1,2,2,6,6-pentamethyl-4-piperidinol and β,β,β′,β′-tetramethyl-2,4,8,10-tetraoxaspiro[5.5] undecane-3,9-diethanol, 1,2,3,4-butanetetracarboxylic acid, tetramethyl ester, reaction products with 2,2,6,6-tetramethyl-4-piperidinol and β,β,β′,β′-tetramethyl-2,4,8,10-tetraoxaspiro[5.5]undecane-3,9-diethanol, bis(1,2,2,6,6-pentamethyl-4-piperidyl)sebacate, bis(2,2,6,6-tetramethyl-4-piperidyl)sebacate, bis(1-undecanoxy-2,2,6,6-tetramethylpiperidin-4-yl)carbonate, 1,2,2,6,6-pentamethyl-4-piperidyl methacrylate, 2,2,6,6-tetramethyl-4-piperidyl methacrylate, 2,2,6,6-tetramethylpiperidin-4-yl hexadecanoate, and 2,2,6,6-tetramethylpiperidin-4-yl octadecanoate.

### <Production of Styrene-Based Resin Composition>

The styrene-based resin composition of the present invention can be obtained by blending and kneading the styrene-based resin (A) having a syndiotactic structure, the styrene-based elastomer (B), the compatibilizer (C), the inorganic filler (D), the colorant (E), and depending on necessity the additional component described above.

The blending and kneading can be performed by a method of preliminarily mixing the components by using an ordinarily used equipment, such as a ribbon blender, a drum tumbler, and a Henschel mixer, and then using a Banbury mixer, a single screw extruder, a twin screw extruder, a multiple screw extruder, a co-kneader, or the like.

The melt-kneaded styrene-based resin composition of the present invention is preferably stored in the form of pellets, and used as a material for a molded article, tableware, microwave oven cookware, and the like, for the production of a molded article, tableware, microwave oven cookware, and the like.

### [Resin Molding Material for Tableware and Resin Molding Material for Microwave Oven Cookware]

The resin molding material for tableware of the present invention contains the styrene-based resin composition described above. Accordingly, the resin molding material for tableware of the present invention contains a styrene-based resin composition containing a styrene-based resin (A) having a syndiotactic structure, a styrene-based elastomer (B), a compatibilizer (C), an inorganic filler (D), and a colorant (E), having a content of the styrene-based elastomer (B) of 2.0 to 30.0% by mass based on the total amount of the styrene-based resin (A) having a syndiotactic structure, the styrene-based elastomer (B) and the compatibilizer (C) as 100% by mass, and a content of the colorant (E) of 0.0001 to 6.5% by mass based on the entire amount of the styrene-based resin composition as 100% by mass.

While the resin molding material for tableware of the present invention may contain another thermoplastic resin or the like in such a range that does not impair the effects of the present invention, the resin molding material for tableware of the present invention may substantially formed of the styrene-based resin composition. Specifically, the content of the styrene-based resin composition in the resin molding material for tableware of the present invention is preferably 90% by mass or more, more preferably 95% by mass or more, and further preferably 99% by mass or more. The upper limit thereof is not limited, may be 100% by mass or less, and preferably 100% by mass, and it may be formed only of the styrene-based resin composition.

The resin molding material for tableware of the present invention has no color unevenness, and is excellent in gloss and also excellent in strength and heat resistance, and therefore is favorably used as a material of tableware as a molded article.

The resin molding material for microwave oven cookware of the present invention contains the styrene-based resin composition described above. Accordingly, the resin molding material for microwave oven cookware of the present invention contains a styrene-based resin composition containing a styrene-based resin (A) having a syndiotactic structure, a styrene-based elastomer (B), a compatibilizer (C), an inorganic filler (D), and a colorant (E), having a content of the styrene-based elastomer (B) of 2.0 to 30.0% by mass based on the total amount of the styrene-based resin (A) having a syndiotactic structure, the styrene-based elastomer (B) and the compatibilizer (C) as 100% by mass, and a content of the colorant (E) of 0.0001 to 6.5% by mass based on the entire amount of the styrene-based resin composition as 100% by mass.

While the resin molding material for microwave oven cookware of the present invention may contain another thermoplastic resin or the like in such a range that does not impair the effects of the present invention, the resin molding material for microwave oven cookware of the present invention may substantially formed of the styrene-based resin composition. Specifically, the content of the styrene-based resin composition in the resin molding material for microwave oven cookware of the present invention is preferably 90% by mass or more, more preferably 95% by mass or more, and further preferably 99% by mass or more. The upper limit thereof is not limited, may be 100% by mass or less, and preferably 100% by mass, and it may be formed only of the styrene-based resin composition.

The resin molding material for microwave oven cookware of the present invention has no color unevenness, and is excellent in gloss and also excellent in strength and heat resistance, and therefore is favorably used as a material of microwave oven cookware as a molded article.

### [Molded Article, Tableware, and Microwave Oven Cookware]

The molded article of the present invention contains the styrene-based resin composition described above. Accordingly, the molded article of the present invention contains a styrene-based resin composition containing a styrene-based resin (A) having a syndiotactic structure, a styrene-based elastomer (B), a compatibilizer (C), an inorganic filler (D), and a colorant (E), having a content of the styrene-based elastomer (B) of 2.0 to 30.0% by mass based on the total amount of the styrene-based resin (A) having a syndiotactic structure, the styrene-based elastomer (B) and the compatibilizer (C) as 100% by mass, and a content of the colorant (E) of 0.0001 to 6.5% by mass based on the entire amount of the styrene-based resin composition as 100% by mass.

The molded article of the present invention can be produced with the styrene-based resin composition as a raw material by an injection molding method, an injection compression molding method, an extrusion molding method, a blow molding method, a press molding method, a vacuum molding method, a foam molding method, or the like. In particular, the molded article is preferably an injection molded article obtained with the styrene-based resin composition in the form of pellets by injection molding or injection compression molding.

The content of the styrene-based resin composition in the molded article of the present invention is preferably 90% by mass or more, more preferably 95% by mass or more, and further preferably 99% by mass or more. The upper limit thereof is not limited, may be 100% by mass or less, and preferably 100% by mass, and it may be formed only of the styrene-based resin composition.

The styrene-based resin composition of the present invention is preferably used as a material for tableware as described above.

Therefore, the tableware of the present invention contains the styrene-based resin composition described above. Accordingly, the tableware of the present invention contains a styrene-based resin composition containing a styrene-based resin (A) having a syndiotactic structure, a styrene-based elastomer (B), a compatibilizer (C), an inorganic filler (D), and a colorant (E), having a content of the styrene-based elastomer (B) of 2.0 to 30.0% by mass based on the total amount of the styrene-based resin (A) having a syndiotactic structure, the styrene-based elastomer (B) and the compatibilizer (C) as 100% by mass, and a content of the colorant (E) of 0.0001 to 6.5% by mass based on the entire amount of the styrene-based resin composition as 100% by mass.

The content of the styrene-based resin composition in the tableware of the present invention is preferably 90% by mass or more, more preferably 95% by mass or more, and further preferably 99% by mass or more. The upper limit thereof is not limited, may be 100% by mass or less, and preferably 100% by mass, and may it be formed only of the styrene-based resin composition.

The tableware of the present invention is preferably obtained by the molding methods described for the molded article above, and examples of the form thereof include a dish form, a bowl form, a pot form, a plate form, a tray form, a bar form, and a box form.

The tableware of the present invention may be subjected to a surface treatment necessary for the standpoint of sanitary and aesthetic design, but has high aesthetic design without printing or coating on the surface thereof since the tableware of the present invention has no color unevenness and is excellent in gloss.

The styrene-based resin composition of the present invention is excellent in strength and heat resistance, and therefore is preferably used as a material of microwave oven cookware as described above.

Therefore, the microwave oven cookware of the present invention contains the styrene-based resin composition described above. Accordingly, the microwave oven cookware of the present invention contains a styrene-based resin composition containing a styrene-based resin (A) having a syndiotactic structure, a styrene-based elastomer (B), a compatibilizer (C), an inorganic filler (D), and a colorant (E), having a content of the styrene-based elastomer (B) of 2.0 to 30.0% by mass based on the total amount of the styrene-based resin (A) having a syndiotactic structure, the styrene-based elastomer (B) and the compatibilizer (C) as 100% by mass, and a content of the colorant (E) of 0.0001 to 6.5% by mass based on the entire amount of the styrene-based resin composition as 100% by mass.

The content of the styrene-based resin composition in the microwave oven cookware of the present invention is preferably 90% by mass or more, more preferably 95% by mass or more, and further preferably 99% by mass or more. The upper limit thereof is not limited, may be 100% by mass or less, and preferably 100% by mass, and may it be formed only of the styrene-based resin composition.

The microwave oven cookware of the present invention is preferably obtained by the molding methods described for the molded article above, and examples of the form thereof include a dish form, a bowl form, a pot form, a plate form, a bar form, a tray form, and a box form.

The microwave oven cookware of the present invention may be subjected to a surface treatment necessary for the standpoint of sanitary and aesthetic design, but has high aesthetic design without printing or coating on the surface thereof since the microwave oven cookware of the present invention has no color unevenness and is excellent in gloss.

### EXAMPLES

The present invention will be described more specifically with reference to examples, but the present invention is not limited to the examples.

The materials used in Examples and Comparative Examples were as follows.

### <SPS (A)>

SPS: Syndiotactic polystyrene resin, racemic pentad: 98% by mol, MFR: 13 g/10 min (temperature: 300° C., load: 1.2 kgf), melting point: 270° C., available from Idemitsu Kosan Co., Ltd.

### <Elastomer>

Septon 8006: Septon 8006, hydrogenated styrene-butadiene-styrene block copolymer (corresponding to styrene-based elastomer (B)), styrene content: 33%, available from Kuraray Co., Ltd.

Engage 8150: Engage 8150, ethylene-octene copolymer (corresponding to olefin-based elastomer), available from Dow Chemical Company

### <Compatibilizer (C)>

Fumaric acid-modified polyphenylene ether (PPE), produced through melt modification, modification amount: 1.5% by mass, available from Idemitsu Kosan Co., Ltd.

### <Inorganic Filler (D)>

T-249H: ECS 03 T-249H, E-glass, fiber form (chopped strand length: 3 mm), approximately circular fiber cross section (diameter: 10.5 μm), treated with silane coupling agent, available from Nippon Electric Glass Co., Ltd.

### <Colorant (E)>

Carbon black: Cabot Black Pearls 4350, available from Cabot Corporation

### <Additional Materials>

Antioxidant, Irganox 1010: Irganox 1010, pentaerythritol tetrakis{3-(3,5-di-tert-butyl-4-hydroxyphenyl)propionate}, available from BASF SE

Crystallization nucleating agent, NA-11: Adeka Stab NA-11, sodium 2,2′-methylenebis(4,6-cli-tert-butylphenyl)phosphate, available from Adeka Corporation

Release agent, SH200CV: SH200CV 13,000 sct, silicone oil, available from Dow Corning Toray Co., Ltd.

### Examples 1 to 4 and Comparative Examples 1 and 2

### (Production of Styrene-Based Resin Composition and Molded Article)

The components other than the inorganic filler (D) were blended at the ratios shown in Table 1 and dry-blended with a Henschel mixer. Subsequently, the resin composition was kneaded with a twin screw kneader (TEM37SS, available from Shibaura Machine Co., Ltd.) having a cylinder diameter of 37 mm at a screw rotation number of 220 rpm and a barrel temperature of 270 to 290° C., with side-feeding of the inorganic filler (D) at a ratio shown in Table 1, so as to produce pellets. The resulting pellets were dried at 120° C. for 5 hours with a hot air dryer, so as to provide styrene-based resin composition pellets. The resulting styrene-based resin composition pellets were evaluated. The evaluation methods were as follows.

(1) Charpy Impact Strength (with Notch)

The styrene-based resin composition pellets were molded into the following molded article (in a strip form with 4 mm in thickness×10 mm in length×80 mm in width) with an injection molding machine (SE100EV, available from Sumitomo Heavy Industries, Ltd.) at a cylinder temperature of 290° C. and a mold surface temperature of 150° C. The resulting molded article was notched with a notching machine, and measured for the Charpy impact strength at a temperature of 23° C. according to ISO 179:2010. A larger value shows better impact resistance (strength and mechanical strength).

### (2) Dielectric Tangent (Tanδ)

The styrene-based resin composition pellets were molded into the following molded article (in a column form with 1.5 mm in length×1.5 mm in width×80 mm in height) with an injection molding machine (SE100EV, available from Sumitomo Heavy Industries, Ltd.) at a cylinder temperature of 290° C. and a mold surface temperature of 150° C. The resulting molded article was measured for the dielectric tangent (tanδ) at 2.45 GHz by the cavity resonance perturbative method according to ASTM D2520 with a network analyzer (8757D, available from Agilent Technologies, Inc.) and a 2.45 GHz cavity resonator (available from EM Labs, Inc.). A smaller value shows a lower transmission loss of electromagnetic waves and a higher heating efficiency of foods.

### (3) Heat Resistance in Microwave Oven Cooking

The styrene-based resin composition pellets were molded into the following molded article (in a box form with 2 mm in thickness×100 mm in length×150 mm in width×10 mm in depth) with an injection molding machine (SE100EV, available from Sumitomo Heavy Industries, Ltd.) at a cylinder temperature of 290° C. and a mold surface temperature of 150° C. Salted mackerel (oil content: 14% by mass) as a high oil content food was placed in the resulting molded article, and after heating with a microwave oven at 800 W for 6 minutes, and taking the content out therefrom, the inner surface of the molded article was observed and evaluated by the following standard.

### (Evaluation Standard)

A: The surface was not melted (high heat resistance)
B: The surface was melted (low heat resistance)

### (4) Foreign Matters

The styrene-based resin composition pellets were molded into the following molded article (in a sheet form with 2 mm in thickness×80 mm in length×80 mm in width) with an injection molding machine (SE100EV, available from Sumitomo Heavy Industries, Ltd.) at a cylinder temperature of 290° C. and a mold surface temperature of 150° C. The resulting molded article was observed for the number of black dots (foreign matters) existing on the front surface and the back surface of the molded article, and the number of foreign matters existing within 100 cm 2 on the surface of the molded article was calculated. A smaller value shows a better appearance.

### (5) Glossiness

The styrene-based resin composition pellets were molded into the following molded article (in a sheet form with 2 mm in thickness×80 mm in length×80 mm in width) with an injection molding machine (SE100EV, available from Sumitomo Heavy Industries, Ltd.) at a cylinder temperature of 290° C. and a mold surface temperature of 150° C. The resulting molded article was measured for the surface glossiness with a glossmeter (VG2000, available from Nippon Denshoku Industries, Co., Ltd.) according to the measurement method 3 in JIS Z8741:1997. A larger value shows a better appearance.

### (6) Color Unevenness

The styrene-based resin composition pellets were molded into the following molded article (in a box form with 2 mm in thickness×100 mm in length×150 mm in width×10 mm in depth) with an injection molding machine (SE100EV, available from Sumitomo Heavy Industries, Ltd.) at a cylinder temperature of 290° C. and a mold surface temperature of 150° C. The resulting molded article was measured for the color at random 15 positions (5 mm in length×10 mm in width for one measured area) on the surface thereof with an integrating sphere spectrophotometer (CE-7000A, available from GretagMacbeth LLC), and the average value of L*, a*, and b* was calculated. Thereafter, the average value and the standard deviation of the color difference ΔE between the average value and each of the measured positions were calculated, and the color unevenness was evaluated by the standard deviation of ΔE. It was assumed that a specimen having a standard deviation of less than 0.2 caused no color unevenness, and a specimen having a standard deviation of 0.2 or more caused color unevenness. A smaller standard deviation shows less color unevenness occurring.

### (7) Deflection Temperature Under Load

The styrene-based resin composition pellets were molded into the following molded article (in a strip form with 4 mm in thickness×10 mm in length×80 mm in width) with an injection molding machine (SE100EV, available from Sumitomo Heavy Industries, Ltd.) at a cylinder temperature of 290° C. and a mold surface temperature of 150° C. The resulting molded article was measured for the deflection temperature under load (load: 1.8 MPa) according to the measurement method of ISO 75-1,2:2004. A higher deflection temperature under load shows better heat resistance.

The evaluation results of the styrene-based resin compositions and the molded articles are shown in Table 1.

TABLE 1

| | | | | | | | | Comparative | Comparative |
|---|---|---|---|---|---|---|---|---|---|
| | | | | Example 1 | Example 2 | Example 3 | Example 4 | Example 1 | Example 2 |
| Styrene-based | SPS (A) | | % by mass | 89.5 | 89 | 88 | 96.5 | 78 | 88 |
| resin | Elastomer | SEPTON 8006 | % by mass | 10 | 10 | 10 | 2.5 | — | — |
| composition | | (styrene-based | | | | | | | |
| and molded | | elastomer (B)) | | | | | | | |
| article | | ENGAGE 8150 | % by mass | — | — | — | — | 20 | 10 |
| (contents of | | (olefin-based elastomer) | | | | | | | |
| components *) | Compatibilizer | Fumaric acid-modified | % by mass | 0.5 | 1 | 2 | 1 | 2 | 2 |
| | (C) | PPE | | | | | | | |
| | Total of (A), elastomer, and (C) (% by mass) | | | 100 | 100 | 100 | 100 | 100 | 100 |
| | Antioxidant | Irganox 1010 | part by | 0.5 | 0.5 | 0.5 | 0.5 | 0.5 | 0.5 |
| | | | mass | | | | | | |
| | Crystallization | NA-11 | part by | 0.5 | 0.5 | 0.5 | 0.5 | 0.5 | 0.5 |
| | nucleating agent | | mass | | | | | | |
| | Total of (A), elastomer, (C), antioxidant, and | | % by mass | 84.45 | 84.45 | 84.45 | 69.45 | 84.5 | 69.7 |
| | crystallization nucleating agent | | | | | | | | |
| | Inorganic filler | ECS 03 T-249H | % by mass | 15 | 15 | 15 | 30 | 15 | 30 |
| | (D) | | | | | | | | |
| | Colorant (E) | Cabot Black Pearls 4350 | % by mass | 0.3 | 0.3 | 0.3 | 0.3 | 0.5 | 0.3 |
| | Release agent | SH200CV 13,000 cst | % by mass | 0.25 | 0.25 | 0.25 | 0.25 | — | — |

| | Entire amount of styrene-based resin composition | 100 | 100 | 100 | 100 | 100 | 100 |
|---|---|---|---|---|---|---|---|
| | (% by mass) | | | | | | |
| Evaluation | Charpy impact strength (with notch) (kJ/m²) | 9 | 10 | 11 | 12 | 11 | 13 |
| | Dielectric tangent (tanδ) (2.45 GHz) | 0.002 | 0.002 | 0.002 | 0.003 | 0.002 | 0.003 |
| | Heat resistance in microwave oven cooking | A | A | A | A | A | A |
| | YI | 17 | 20 | 27 | 20 | 27 | 27 |
| | Foreign matters (per 100 cm²) | 0.6 | 0.9 | 3.4 | 0.9 | 3.4 | 3.4 |
| | Glossiness (Gs 60°) (%) | 91 | 91 | 91 | 83 | 90 | 77 |
| | Color unevenness | 0.05 | 0.05 | 0.05 | 0.07 | 0.22 | 0.10 |
| | Deflection temperature under load (1.8 MPa) | 230 | 230 | 230 | 250 | 140 | 240 |
| | (° C.) | | | | | | |

*: Contents of components: percentage by mass based on total amount of (A), elastomer, and (C) as 100% by mass, for (A), elastomer, and (C), part by mass per 100 parts by mass of total amount of (A), elastomer and (C) for antioxidant and crystallization nucleating agent, and percentage by mass based on entire amount of styrene-based resin composition as 100% by mass, for (D), (E), and release agent.

It is understood from the results of the examples that the styrene-based resin composition and the molded article of the present invention have no color unevenness, and is excellent in gloss and also excellent in strength and heat resistance. In particular, it is understood therefrom that the mechanical strength, such as the impact resistance, is excellent. Accordingly, the styrene-based resin composition of the present invention is useful as a molding material for tableware, and is particularly useful as a molding material for microwave oven cookware due to the low transmission loss of electromagnetic waves and the excellent heat resistance in storing a high oil content food.

While the embodiments and/or the examples of the present invention have been described in detail above, a skilled person in the art can easily make various changes on the embodiments and/or the examples without departing from the novel teachings and effects of the present invention. Therefore, these changes are also encompassed in the scope of the present invention.

The contents of the literatures cited in the description herein and the contents of the patent application, based on which the present application claims the priority based on the Paris Convention, are all incorporated herein by reference.

1. A styrene-based resin composition comprising a styrene-based resin (A) having a syndiotactic structure, a styrene-based elastomer (B), a compatibilizer (C), an inorganic filler (D), and a colorant (E),
having a content of the styrene-based elastomer (B) of 2.0 to 30.0% by mass based on the total amount of the styrene-based resin (A) having a syndiotactic structure, the styrene-based elastomer (B) and the compatibilizer (C) as 100% by mass, and a content of the colorant (E) of 0.0001 to 6.5% by mass based on the entire amount of the styrene-based resin composition as 100% by mass.

2. The styrene-based resin composition according to claim 1, wherein the styrene-based elastomer (B) is at least one kind selected from the group consisting of a styrene-diene block copolymer, a hydrogenated styrene-diene block copolymer, a styrene-diene random copolymer, a hydrogenated styrene-diene random copolymer, and a styrene-olefin random copolymer.

3. The styrene-based resin composition according to claim 1, wherein the styrene-based elastomer (B) is at least one kind selected from the group consisting of a styrene-butadiene block copolymer, a hydrogenated styrene-butadiene block copolymer, a styrene-butadiene-styrene block copolymer, a hydrogenated styrene-butadiene-styrene block copolymer, a styrene-isoprene block copolymer, a hydrogenated styrene-isoprene block copolymer, a styrene-isoprene-styrene block copolymer, a hydrogenated styrene-isoprene-styrene block copolymer, a styrene-butadiene random copolymer, a hydrogenated styrene-butadiene random copolymer, a styrene-ethylene-propylene random copolymer, and a styrene-ethylene-butylene random copolymer.

4. The styrene-based resin composition according to claim 2, wherein the styrene-based elastomer (B) has a mass ratio of a structural unit derived from styrene and the total of structural units derived from the diene, the hydrogenated diene, and the olefin ((styrene)/(diene, hydrogenated diene, olefin)) of 20/80 to 70/30.

5. The styrene-based resin composition according to claim 1, wherein the compatibilizer (C) is a modified polyphenylene ether.

6. The styrene-based resin composition according to claim 1, wherein the styrene-based resin composition has a content of the compatibilizer (C) of 0.4 to 5.0% by mass based on the total amount of the styrene-based resin (A) having a syndiotactic structure, the styrene-based elastomer (B), and the compatibilizer (C) as 100% by mass.

7. The styrene-based resin composition according to claim 1, wherein the inorganic filler (D) is a glass filler.

8. The styrene-based resin composition according to claim 1, wherein the styrene-based resin composition has a content of the inorganic filler (D) of 5 to 50% by mass based on the entire amount of the styrene-based resin composition as 100% by mass.

9. The styrene-based resin composition according to claim 1, wherein the inorganic filler (D) is treated with a silane-based coupling agent or a titanium-based coupling agent.

10. The styrene-based resin composition according to claim 1, wherein the colorant (E) is at least one kind selected from the group consisting of carbon black, an inorganic pigment, an organic pigment, and an organic dye.

11. The styrene-based resin composition according to claim 10, wherein the inorganic pigment is at least one kind selected from the group consisting of titanium dioxide, iron oxide, nickel titanium yellow, zinc sulfide, barium sulfate, and ultramarine.

12. The styrene-based resin composition according to claim 10, wherein the organic pigment is at least one kind selected from the group consisting of a monoazo pigment, a perylene pigment, a quinacridone pigment, and a phthalocyanine pigment.

13. The styrene-based resin composition according to claim 1, wherein the colorant (E) is at least one kind selected from the group consisting of carbon black, an inorganic pigment, an organic pigment, and an organic dye, and the styrene-based resin composition has a content of the colorant (E) of 0.0001% by mass or more, a content of the carbon black of 2.5% by mass or less, a content of the inorganic pigment of 3.0% by mass or less, and a total content of the organic pigment and the organic dye of 1.0% by mass or less, all based on the entire amount of the styrene-based resin composition as 100% by mass.

14. The styrene-based resin composition according to claim 1, wherein the styrene-based resin composition comprises substantially no olefin-based elastomer.

15. A resin molding material for a table ware, comprising the styrene-based resin composition according to claim 1.

16. A resin molding material for microwave oven cookware, comprising the styrene-based resin composition according to claim 1.

17. A molded article comprising the styrene-based resin composition according to claim 1.

18. Tableware comprising the styrene-based resin composition according to claim 1.

19. Microwave oven cookware comprising the styrene-based resin composition according to claim 1.
